(19) United States
(12) Patent Application Publication
(10) Pub. No.: US 2012/0224482 A1
(43) Pub. Date: Sep. 6, 2012

(54) CREDIT FEEDBACK SYSTEM FOR PARALLEL DATA FLOW CONTROL

(75) Inventors: James Warren Gramling, Mission Viejo, CA (US); Paul Herman Dyke, Mission Viejo, CA (US); Subhankar Aich, Irvine, CA (US)

(73) Assignee: MICROSOFT CORPORATION, Redmond, WA (US)

(21) Appl. No.: 13/040,111

(22) Filed: Mar. 3, 2011

(51) Int. Cl. H04L 12/26

(52) U.S. Cl. 370/231

(57) ABSTRACT

A producer node receives data that is to be transmitted to a consumer node. The producer node receives a credit indication from the consumer node indicating that a portion of credit has been extended to the producer node. The credit portion specifies the amount of data that is to be sent to the consumer node. The producer node sends the amount of data specified in the credit indication to the consumer node. The consumer node receives data that is to be processed. The consumer node returns the portion of credit indicated in the credit indication to a credit pool, where, upon addition to the credit pool, the credit is made available for distribution to the producer node. The consumer node sends a new credit indication to the producer node indicating a specified amount of data that is to be sent to the consumer node to be processed.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed facilitate communication between various computer systems. For example, a client-side software application may be configured send data to a server computer system or database. The client-side application may be designed to send data as fast as the data is generated. The server or database may not be able to process the data as fast as the client-side application is sending the data.

### BRIEF SUMMARY

Embodiments described herein are directed to implementing a credit-driven data flow control mechanism. In one embodiment, a producer node receives data that is to be transmitted to a consumer node. The producer node further receives a credit indication from the consumer node indicating that a portion of credit has been extended to the producer node. The credit portion specifies the amount of data that is to be sent to the consumer node. The producer node also, based on the received credit indication, sends the amount of data specified in the credit indication to the consumer node.

In another embodiment, a consumer node receives data that is to be processed by a database system. For instance, the data may be written to disk on a database computer system. The data includes a credit indication from a producer node indicating that a portion of credit is to be returned to the consumer node. The consumer node returns the portion of credit indicated in the credit indication to a credit pool, where, upon addition to the credit pool, the credit is made available for distribution to the producer node. The consumer node sends a new credit indication to the producer node indicating a specified amount of data that is to be sent to the consumer node to be written to disk.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including implementing a credit-driven data flow control mechanism.

FIG. 2 illustrates a flowchart of an example method for implementing a credit-driven data flow control mechanism.

FIG. 3 illustrates a flowchart of an alternative example method for implementing a credit-driven data flow control mechanism.

### DETAILED DESCRIPTION

Embodiments described herein are directed to implementing a credit-driven data flow control mechanism. In one embodiment, a producer node receives data that is to be transmitted to a consumer node. The producer node further receives a credit indication from the consumer node indicating that a portion of credit has been extended to the producer node. The credit portion specifies the amount of data that is to be sent to the consumer node. The producer node also, based on the received credit indication, sends the amount of data specified in the credit indication to the consumer node.

In another embodiment, a consumer node receives data that is to be processed at a database computer system. For instance, the data may be written to disk on a database computer system. The data includes a credit indication from a producer node indicating that a portion of credit is to be returned to the consumer node. The consumer node returns the portion of credit indicated in the credit indication to a credit pool, where, upon addition to the credit pool, the credit is made available for distribution to the producer node. The consumer node sends a new credit indication to the producer node indicating a specified amount of data that is to be sent to the consumer node to be written to disk.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry data or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks (e.g. cloud computing, cloud services and the like). In a distributed system environment, program modules may be located in both local and remote memory storage devices.

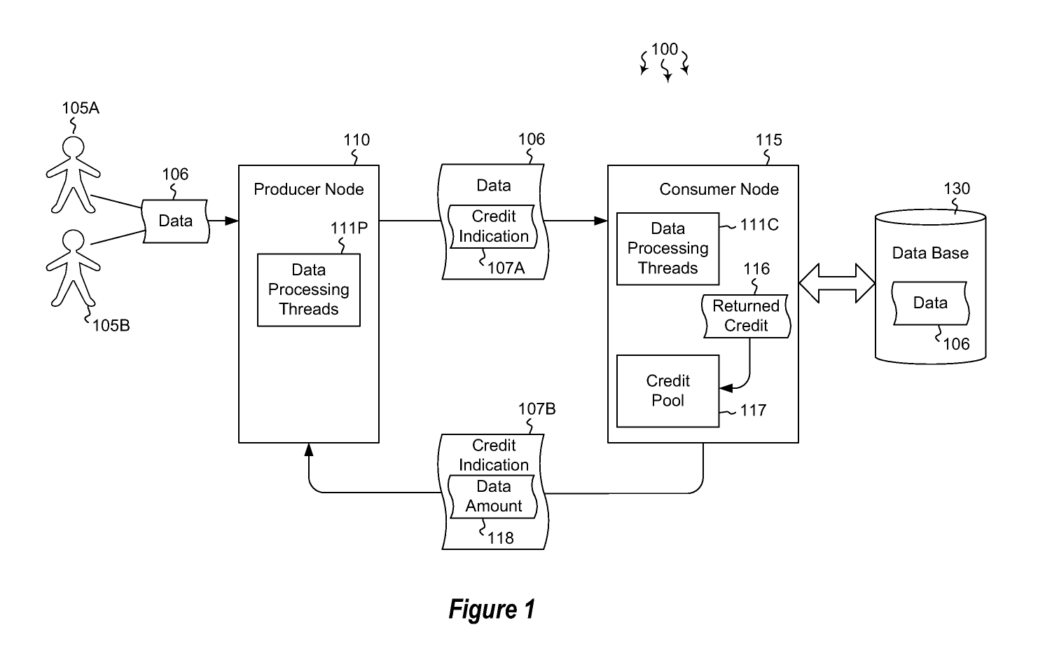

FIG. 1 illustrates a computer architecture 100 in which the principles of the present invention may be employed. Computer architecture 100 includes producer node 110 and consumer node 115. As used herein, the term producer node may refer to any type of computing system (distributed or local) that produces data. The data may be any type of data including files, user data, application-related data or other types of data. The producer node includes one or more processing threads 111P. These threads may be instantiated by the producer node to perform work. The processing threads may be assigned to process various different tasks. In some cases, each thread may be assigned to a different task, while in other cases, groups of threads may be assigned to a common task. The producer node may process data 106. Data 106 may be sent from various different computer users 105A/105B. The data may also be sent from other computer systems, other software applications, or other users or groups of users. The producer node may send the data to the consumer node to be processed in some manner.

Consumer node 115, like the producer node, may comprise any type of computing system. The consumer node includes one or more data processing threads 111C that perform various tasks. In some cases, the threads may receive the data sent from the producer node and perform any desired processing. The processing may include any type of processing including sending the data to the query processor of a database engine, performing specialized processing, and/or writing the data to disk. The consumer node may write the data to disk locally, or may send the data to a data store 130. Data store 130 may be any type of local, network (e.g. storage area network (SAN)) or distributed (e.g. cloud storage) data store. The data 106 may be stored in the data store until it is later deleted or moved.

Consumer node 115 includes a credit pool 117. The credit pool may comprise a store of credit that may be extended to the producer node. When the consumer node extends credit to the producer node, the producer node can send data to the consumer node. Thus, the consumer node can indicate its current ability to process resources in the amount of credit it extends to the producer node. Accordingly, in some embodiments, if the consumer node has the current ability to process ten portions of data, the consumer node can indicate in credit indication 107B that ten portions of credit are extended to the producer node. (In this example, ten portions of credit would indicate a data amount 118 of ten portions which could be transferred to the consumer node for transfer to disk or other processing).

The producer node may acknowledge that a given amount of credit has been extended to it (in the example above, ten portions). The producer may then send that amount of data 106 to the consumer node, along with a credit indication 107A that indicates how much credit was used. In some cases, the producer node may not use the full amount of credit and may store the remaining portion for later use. For example, if the consumer node extended ten portions of credit to the producer, and the producer used eight portions, the producer would send eight portions of data 106, along with a credit indication indicating that eight portions of credit had been used, to the consumer node. In various different embodiments, the producer node may or may not be able to retain the unused credit. In cases where the producer keeps the unused credit, the credit may be stored in a producer-side credit pool. In cases where the producer cannot keep the unused credit, the remaining unused credit is returned 116 to consumer-side credit pool 117.

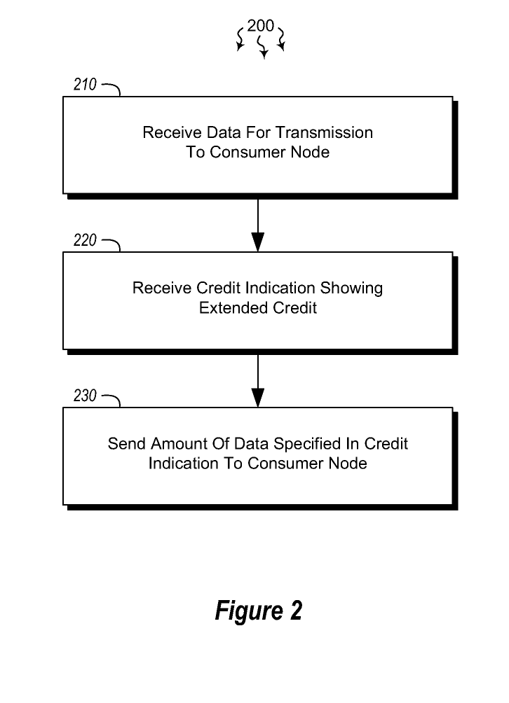

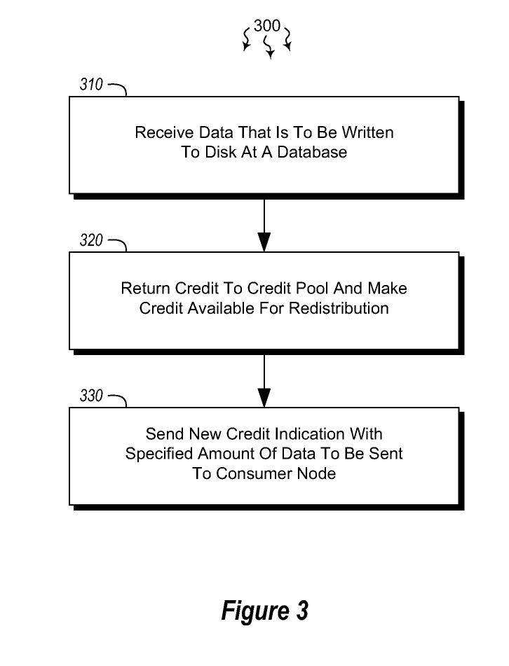

The credit indications 107A/107B may indicate the allotment of credit in various different manners. For instance, a credit portion may indicate the amount of data in bytes that the producer node can send to the consumer node. Additionally or alternatively, the credit portion may indicate a total number of files that can be sent, or a number of queries that can be processed. Still further, the credit indication may indicate a data transfer rate that can be used for a given time period (e.g. fifty megabytes per second). Many other credit indications are possible, and the examples provided herein should not be read as limiting the forms in which credit may be extended. The processes outlined above will be described in greater detail below with regard to methods 200 and 300 of FIGS. 2 and 3.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for implementing a credit-driven data flow control mechanism. The method 200 will now be described with frequent reference to the components and data of environment 100.

Method 200 includes an act of receiving at a producer node data that is to be transmitted to a consumer node (act 210). For example, producer node 110 may receive data 106 from either or both of users 105A/105B that is to be transmitted to consumer node 115. The data received by the producer node may include various types of data that is to be stored or otherwise processed. Producer nodes may be configured to send large quantities of data to consumer nodes. In some cases, the producer node may include (or instantiate) many different data processing threads 111P that are each capable of processing and transmitting data to the consumer node.

In some embodiments, the data store 130 may comprise a parallel data warehouse. As used herein, a parallel data warehouse may refer to a data store that allows multiple simultaneous data connections, so that large amounts of data can be written concurrently. For instance, multiple (e.g. many thousands or millions of) different users may be interacting with the parallel data warehouse at the same time. The users may be sending queries that initiate the processing and storing of massive amounts of data. In response to the queries, the producer node may instantiate multiple different data processing threads to process the users' queries. Moreover, in response to the request, the consumer node can issue credit to the producer node indicating that the consumer node has processing capacity. The credit indication may also indicate how much capacity the consumer node currently has.

Method 200 includes an act of receiving at the producer node a credit indication from the consumer node indicating that a portion of credit has been extended to the producer node, wherein the credit portion specifies the amount of data that is to be sent to the consumer node (act 220). For example, producer node 110 may receive credit indication 107B from consumer node 115 indicating that a certain portion of credit has been extended to the producer node. As mentioned above, the credit portion may indicate an amount of data 118 that is to be sent to the consumer node. Additionally or alternatively, the credit portion may indicate a total number of files that can be sent, a number of queries that can be processed or a data transfer rate that can be used for a given time period. The credit extended may be to a specific client or computer system identified by a unique identifier.

The portion of credit extended to the producer node is taken from a credit pool 117 managed by the consumer node. In some embodiments, the size of the credit pool may be adjustable by adding or removing processing threads on the consumer node. Accordingly, if a larger credit pool is desired, more data processing threads 111C may be added to the consumer node. Alternatively, if a smaller credit pool is desired, data processing threads may be removed from the consumer node. In some cases, the credit pool may include multiple credit counters that track, on a per-consumer-processing-thread basis, the current state of the credit pool. The credit counters may thus track the processing usage of each of data processing threads. The counters may track each thread individually, or groups of threads that are processing a common task.

When data is received and then processed, credit in the credit pool may be increased by the amount of data received at the consumer node 115. Accordingly, if ten portions of data had finished processing at the consumer node, ten portions of credit may be returned to the credit pool (e.g. returned credit 116). The returned credit may then be extended to other users or entities. The consumer node may extend credit to a user, to a user group, to an application, or to any other specified entity. Credit may also be returned in the same manner.

Method 200 includes, based on the received credit indication, an act of the producer node sending the amount of data specified in the credit indication to the consumer node (act 230). For example, producer node 110 may, based on received credit indication 107B, send the amount of data specified in the credit indication to consumer node 115. In some embodiments, the rate at which data is transmitted by the producer node to the consumer node adapts dynamically to mirror the rate at which data is consumed, processed and/or written to disk by the consumer node. Accordingly, if the data is being written to disk at X megabytes or gigabytes per second, credit may be automatically extended and used in such a manner that the data transfer rate from the producer node to the consumer node is substantially the same as the rate data is being written to disk. In this manner, buffer overrun errors may be prevented, as the consumer node is not able to extend more credit than it has the ability to process the data.

In some cases, the producer node may begin sending data to the consumer node as soon as at least one portion of credit has been extended by the consumer. Accordingly, in cases where multiple data processing threads are to be instantiated at the consumer node, not all of the threads need to be up and running before data can be sent by the producer node. Thus, for instance, the consumer node may instantiate a worker thread and then send a credit indication allowing an amount of data to be sent that can be processed by that thread. As other threads come online on the consumer node, more credit may be extended. In this manner, data processing threads on the producer can safely start up and begin producing before the data processing threads on the consumer node have started up. Any data ready for sending on the producer side will be queued until the consumer side extends the producer credit, indicating the producer's readiness to process the data.

FIG. 3 illustrates a flowchart of an alternative method 300 for implementing a credit-driven data flow control mechanism. The method 300 will now be described with frequent reference to the components and data of environment 100 of FIG. 1.

Method 300 includes an act of receiving at a consumer node data that is to be written to disk on a database computer system, wherein the data further includes a credit indication from a producer node indicating that a portion of credit is to be returned to the consumer node (act 310). For example, consumer node 115 may receive data 106 that is to be written to disk in database 130. The received data may include credit indication 107A indicating a portion of credit that is to be returned to the consumer node as soon as the data is processed. Consumer node 115 may instantiate various data processing threads 111C to help process the received data 106. The processing threads may be instantiated for a single task only, or may be instantiated for use with multiple tasks.

Method 300 includes an act of returning the portion of credit indicated in the credit indication to a credit pool, wherein upon addition to the credit pool, the credit is made available for distribution to the producer node (act 320). For example, the consumer node 115 may return the amount of credit indicated in credit indication 107A to the credit pool 117 (i.e. returned credit 116). Once the credit has been returned to the credit pool, the credit can again be made available to the producer node in a credit indication 107B. As mentioned above, the size of the credit pool may be adjustable by adding or removing processing threads on the consumer node. In some cases, the consumer node may be able to dynamically adjust the size of the credit pool by instantiating new data processing threads 111C, or by removing previously instantiated threads. Additionally or alternatively, in cases where the threads are hardware threads, additional processors or processing cores may be added to or removed from the consumer node to adjust the size of the credit pool.

Method 300 includes an act of the consumer node sending a new credit indication to the producer node indicating a specified amount of data that is to be sent to the consumer node to be written to disk (act 330). For example, consumer node 115 may send credit indication 107B to producer node 110 indicating a specified amount of data 118 that is to be sent to the consumer node for specified processing and/or storage in data store 130. As the consumer node continually indicates its ability and capacity to accept new data for processing, and does not allow requests to be received without an attached credit indication (which indicates that credit was extended to the sender), the producer node will not send more data than the consumer node has the ability to process. In some cases, the rate at which data is transmitted by the producer node to the consumer node can adapt dynamically to mirror the rate at which data is processed by the consumer node.

Accordingly, methods, systems and computer program products are provided which implement a credit-driven data flow control mechanism. The credit-driven data flow control mechanism regulates data flow between producer and consumer nodes in such a manner that overrun errors are avoided.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a database computer system including at least one processor and a memory, in a computer networking environment including a plurality of computing systems, a computer-implemented method for implementing a credit-driven data flow control mechanism, the method comprising:
an act of receiving at a producer node data that is to be transmitted to a consumer node;
an act of receiving at the producer node a credit indication from the consumer node indicating that a portion of credit has been extended to the producer node, wherein the credit portion specifies the amount of data that is to be sent to the consumer node; and
based on the received credit indication, an act of the producer node sending the amount of data specified in the credit indication to the consumer node.

2. The method of claim 1, wherein the received data comprises multiple data queries that are to be processed concurrently.

3. The method of claim 2, wherein the multiple data queries are received from a plurality of different database users.

4. The method of claim 1, wherein the database computer system instantiates a plurality of producer processing threads at the producer node.

5. The method of claim 1, wherein the portion of credit extended to the producer node is taken from a credit pool managed by the consumer node.

6. The method of claim 5, wherein the size of the credit pool is adjustable by adding or removing processing threads on the consumer node.

7. The method of claim 5, wherein the credit pool comprises a plurality of credit counters that track, on a per-consumer-processing-thread basis, the current state of the credit pool.

8. The method of claim 5, wherein credit in the credit pool is increased by the amount of data received at the consumer node.

9. The method of claim 1, wherein the rate at which data is transmitted by the producer node to the consumer node adapts dynamically to mirror the rate at which data is processed by the consumer node.

10. The method of claim 5, wherein the credit pool extends credit on a per-user basis.

11. The method of claim 5, wherein the credit pool extends credit on a per-application basis.

12. A computer program product that processes a method for implementing a credit-driven data flow control mechanism, the computer program product comprising one or more computer-readable storage media having stored thereon computer-executable instructions that, when executed by one or more processors of the computing system, cause the computing system to perform the method, the method comprising:
an act of receiving at a consumer node data that is to processed on a database computer system, wherein the data further includes a credit indication from a producer node indicating that a portion of credit is to be returned to the consumer node;
an act of returning the portion of credit indicated in the credit indication to a credit pool, wherein upon addition to the credit pool, the credit is made available for distribution to the producer node; and
an act of the consumer node sending a new credit indication to the producer node indicating a specified amount of data that is to be sent to the consumer node to be processed.

13. The computer program product of claim 12, wherein a plurality of consumer processing threads are instantiated at the consumer node.

14. The computer program product of claim 12, wherein the size of the credit pool is adjustable by adding or removing processing threads on the consumer node.

15. The computer program product of claim 12, wherein the credit pool comprises a plurality of credit counters that track, on a per-consumer-processing-thread basis, the current state of the credit pool.

16. The computer program product of claim 12, wherein the rate at which data is transmitted by the producer node to the consumer node adapts dynamically to mirror the rate at which data is processed by the consumer node.

17. A computer system comprising the following:
one or more processors;
system memory;
one or more computer-readable storage media having stored thereon computer-executable instructions that, when executed by the one or more processors, causes the computing system to perform a method for implementing a credit-driven data flow control mechanism, the method comprising the following:
an act of receiving at a producer node data that is to be transmitted to a consumer node;
an act of receiving at the producer node a credit indication from the consumer node indicating that a portion of credit has been extended to the producer node, wherein the credit portion specifies the amount of data that is to be sent to the consumer node, and wherein the portion of credit extended to the producer node is taken from a credit pool managed by the consumer node, the credit pool including a plurality of credit counters that track, on a per-consumer-processing-thread basis, the current state of the credit pool; and
based on the received credit indication, an act of the producer node sending the amount of data specified in the credit indication to the consumer node.

18. The system of claim 17, wherein the size of the credit pool is adjustable by adding or removing processing threads on the consumer node.

19. The system of claim 17, wherein credit in the credit pool is increased by the amount of data received at the consumer node.

20. The system of claim 17, wherein the rate at which data is transmitted by the producer node to the consumer node adapts dynamically to mirror the rate at which data is written to disk by the consumer node.
